(19) United States
(12) Patent Application Publication
(10) Pub. No.: US 2017/0149218 A1
(43) Pub. Date: May 25, 2017

(54) ARC-RESISTANT SWITCHGEAR RACKING SYSTEM

(71) Applicant: PACS SWITCHGEAR LLC, Bethpage, NY (US)

(72) Inventors: Niel MIELE, Bethpage, NY (US); William RILEY, Mansfield, OH (US)

(21) Appl. No.: 14/946,112

(22) Filed: Nov. 19, 2015

(51) Int. Cl. H02B 11/24

(52) U.S. Cl. CPC H02B 11/24

(57) ABSTRACT

An arc-resistant electrical switchgear racking system includes arc-resistant electrical switchgear that has a chamber and an arc-resistant door configured to enclose the chamber. The arc-resistant electrical switchgear racking system further includes an internal racking mechanism disposed inside the chamber, the internal racking mechanism configured to facilitate connection and disconnection of electrical components inside the chamber. The arc-resistant electrical switchgear racking system further includes a door component disposed in the arc-resistant door, wherein the door component is configured to engage the racking mechanism to provide an arc-resistant interface for accessing the internal racking mechanism.

### FIELD OF THE DISCLOSURE

The present disclosure relates to electrical switchgear and more particularly to an arc-resistant electrical switching gear having an arc-resistant, through door, racking system.

### BACKGROUND

Electrical switchgear is commonly used in power systems to isolate and protect electrical equipment against overload and short circuit currents and other failures. Switchgear is also used to control and meter electrical power systems. Electrical switchgear includes components such as circuit breakers, transformers, protection relays, measuring instruments, electrical switches and fuses, and lightening and surge arrestors. Failure of the electrical components and the switchgear can result in arc flashover or an electrical explosion.

Explosions due to arc flashover in electrical switchgear can produce a blast of significant magnitude which can be dangerous and harmful to operators, repair technicians, or others in the vicinity of the switchgear during the blast. Thus, manufacturers have developed robust enclosures to contain this event and direct the blast away from areas that may be occupied by operations personnel or the public. Doors of such arc-resistant switchgear are tested to ensure that they can withstand the pressures of a potential arc fault in the chamber directly behind them as any opening or penetration in the door can be catastrophic.

FIG. 1 illustrates example known electrical switchgear 100. The components that are housed in the chamber of the switchgear 100, such a as circuit breaker 102, are commonly disconnected from the live circuitry by way of internal racking mechanisms (not shown) for maintenance, repair, or replacement. In order to reach these mechanisms, however, a tool 104, such as a handle, crank, motor driven socket, etc. must pass through an opening or an access port 106 in the door 108 to operate the internal racking mechanism, which may compromise the arc-resistance of the switch gear 100. Such a compromise may result in damage to equipment or injury to personnel.

### SUMMARY

An arc-resistant electrical switchgear racking system includes arc-resistant electrical switchgear that has a chamber and an arc-resistant door configured to enclose the chamber. The arc-resistant electrical switchgear racking system further includes an internal racking mechanism disposed inside the chamber, the internal racking mechanism configured to facilitate connection and disconnection of electrical components inside the chamber. The arc-resistant electrical switchgear racking system further includes a door component disposed in the arc-resistant door, wherein the door component is configured to engage the racking mechanism to provide an arc-resistant interface for accessing the internal racking mechanism.

A door component provides an arc-resistant interface for accessing the internal racking mechanism of an arc-resistant electrical switchgear. The door component includes a shaft with a collar disposed on an end of the shaft, the shaft configured to rotate and move laterally and engage the internal racking mechanism responsive to being engaged by a hand tool external to the arc-resistant electrical switchgear. The door component further includes a slide comprising a guide hole for receiving the shaft, and a flat portion for engaging the collar of the shaft on a first side of the slide to form a seal, the slide configured to move laterally in combination with the shaft responsive to the collar applying a force to the first side of the slide. The door component further includes a compression spring configured to provide pressure against the second side of the slide to facilitate engagement of the collar with the first side of the slide.

A method for providing arc-resistant access to an internal racking mechanism of an arc-resistant electrical switchgear includes the steps of disposing an arc-resistant door component comprising a shaft inside an arc-resistant door of an electrical switchgear. The method further includes the step of closing the arc-resistant door to create an arc-resistant seal. The method further includes the step of engaging the shaft of the arc-resistant door component, externally to the door, with a hand tool, thereby causing the shaft to telescope through the arc-resistant door component and engage with a racking screw of the internal racking mechanism.

### BRIEF DESCRIPTION OF THE DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale and the proportion of certain elements may be exaggerated for the purpose of illustration.

FIG. 1 illustrates example known electrical switchgear.

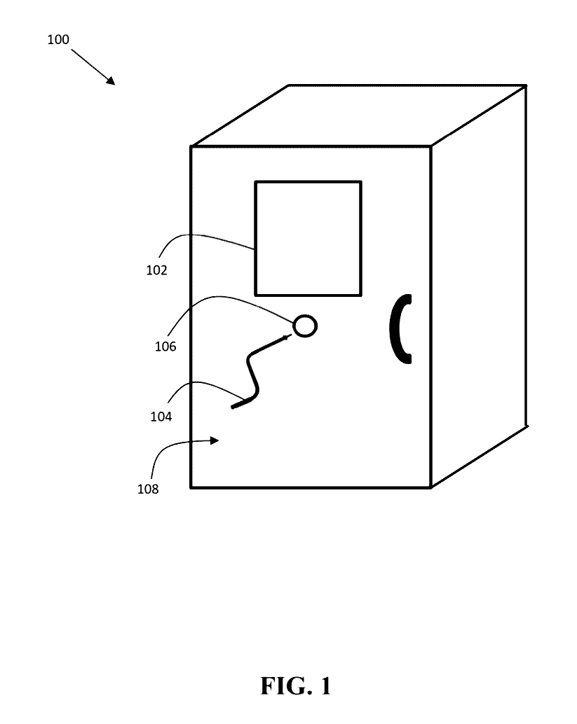

FIG. 2 illustrates an example arc-resistant switchgear racking system.

FIG. 3 illustrates an example arc-resistant door component.

FIG. 4 illustrates an example arc-resistant door component in more detail.

FIG. 5 illustrates an example method for providing arc-resistant access to an internal racking mechanism of an arc-resistant electrical switchgear.

FIGS. 6A-6C illustrate an example arc-resistant switchgear racking system.

### DETAILED DESCRIPTION

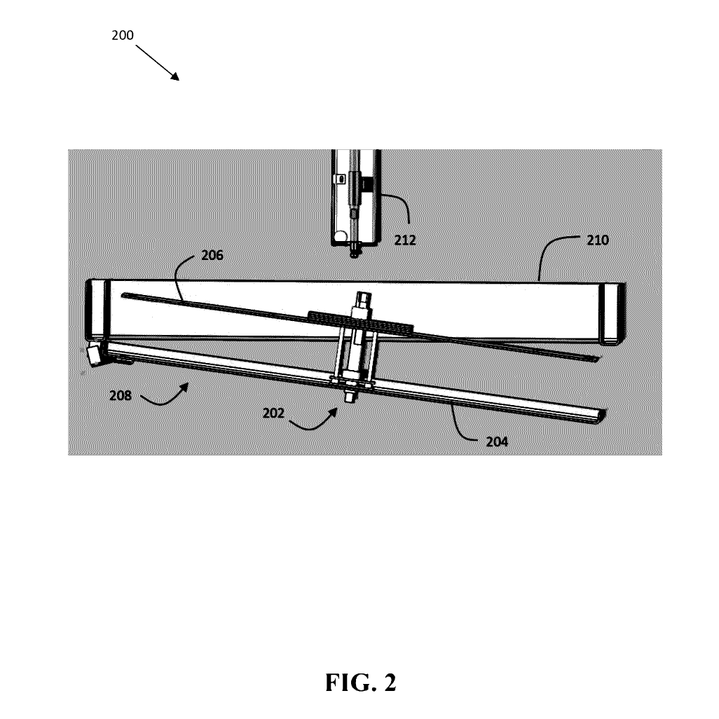

Described herein is an arc-resistant switchgear racking system that provides an arc-resistant interface through which an operator can safely insert and withdraw tools for connecting, disconnecting, inserting, and removing electrical switchgear components. FIG. 2 illustrates an example arc-resistant switchgear racking system 200. The racking system 200 includes an arc-resistant switchgear door component (hereinafter referred to as “the door component”) 202 mounted between a front door skin 204 and a rear door skin 206 of a switchgear door 208. The switchgear door 208 is configured to open and close in order to provide access to the inside of the chamber 210. When the door 208 is in a closed position, the door component 202 is configured to align with and engage an internal racking mechanism 212 in such a way as to create an arc-resistant interface through which a crank or other hand tool may safely be used without compromising the arc-resistance of the door 208 and chamber 210.

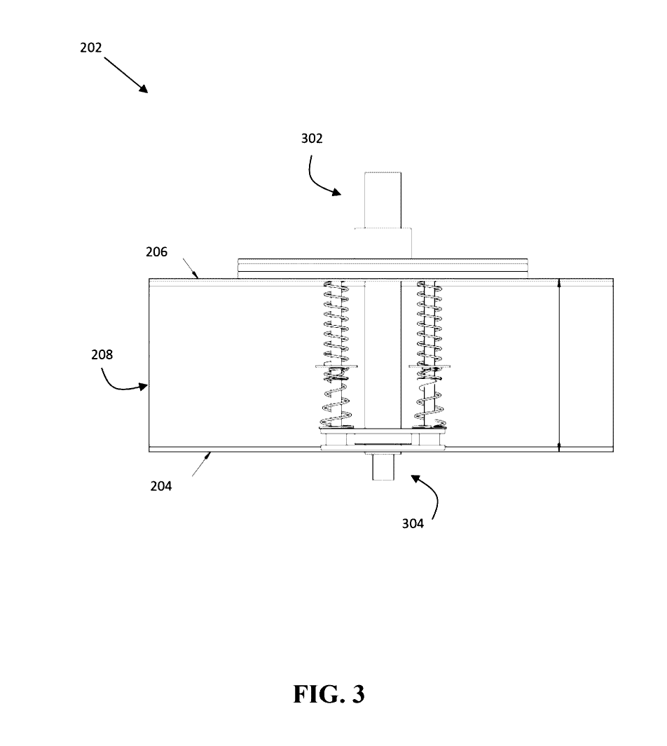

FIG. 3 illustrates a more detailed view of the example door component 202 mounted to the switchgear door 208. It should be appreciated that although the example door component 202 is described as being mounted between the front door skin 204 and the rear door skin 206 of a switchgear door 208, some rear portions 302 of the door component 202 may extend beyond the rear door skin 206 while some front portions 304 of the door component 202 may extend beyond the front door skin 204 in order to facilitate engagement with the internal racking mechanism 212 and receiving of a hand tool 104.

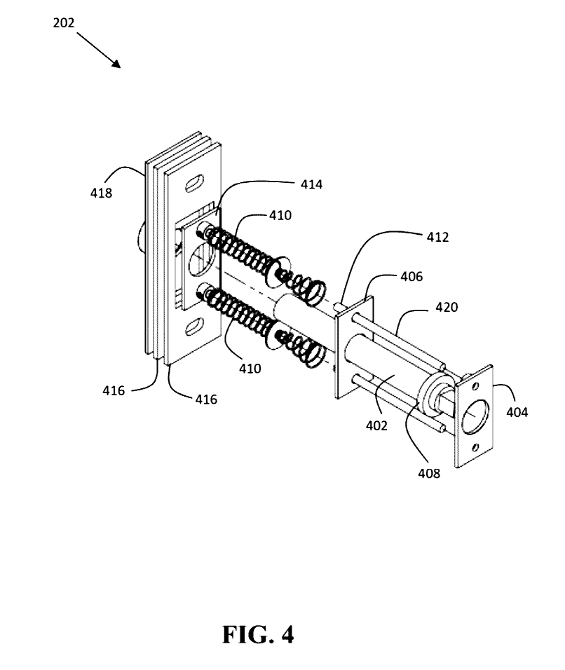

FIG. 4 illustrates an example door component 202 in more detail. The door component 202 includes a shaft 402 configured to match a component racking mechanism screw and handle inside a chamber of electrical switchgear such that the shaft 402 is able to engage the racking mechanism in order to cause internal components of the chamber to be connected or disconnected from live circuitry based on a force applied to the shaft 402 from outside the door and chamber. In one example, the shaft 402 machined from steel stock, although it should be appreciated that the shaft 402, as well as other parts of the door components 202, may comprise any suitable material for creating an arc-resistant seal while still providing access to the internal racking system.

The door component 202 includes a front mounting plate 404 for mounting the door component to a front door skin of a switchgear door. The door component 202 further includes a slide 406 which receives the shaft 402 through a guide hole and allows the shaft 402 to rotate and slide laterally. The shaft 402 includes a collar 408 positioned between the front mounting plate 404 and the slide 406 and configured to engage a flat portion of the slide 406, creating a flush seal. As the shaft 402 telescopes through the door and into the chamber to engage the racking mechanism, the collar 408 of the shaft 402 engages the slide 406 and forces the slide 406 to move laterally in combination with the shaft 402. In addition, the collar 408, engaged with the slide 406, forms a barrier that will prevent an arc blast from passing through the door component and out from the switchgear.

The door component includes dual compression springs 410 around guide rails 412 that provide constant pressure on the slide for full contact between the slide 406 and the collar 408. Thus, in the event of an arc flash, the pressure seals the slide 406 against the collar 408 so that the explosion cannot pass to the front mounting plate 404. The spring pairs 410 also ensure even and linear movement of the slide 406 and shaft 402 pair along the guide rods 420.

The door component 202 includes inner slide support 414 and rear spacers 416 to assure proper alignment and eliminate twisting as the shaft 402 rotates. It should be appreciated that although two rear spacers 416 are illustrated, the door component 202 may include one or more than two rear spacers 416, as deemed suitable.

The door component 202 includes a rear guide plate or mounting plate 418, which is mounted on the inner skin of the door and is configured to mate with an internal component racking screw housing for proper alignment.

In one example, guide holes in the front mounting plate 404, the slide 406, and the rear mounting plate 418 are larger than the diameter of the shaft 402 to allow the shaft 402 some “float” to self-align itself with the component racking screw. In one example, when installed into an arc-resistant door, the only noticeable part is the front of the shaft 402.

In one example, protective cowl (not shown) encloses the entire door component 202 and shields it from external dirt. In one example, no service or alignment is required once properly installed. In another example, if service or alignment may be required, the protective cowl may be removable.

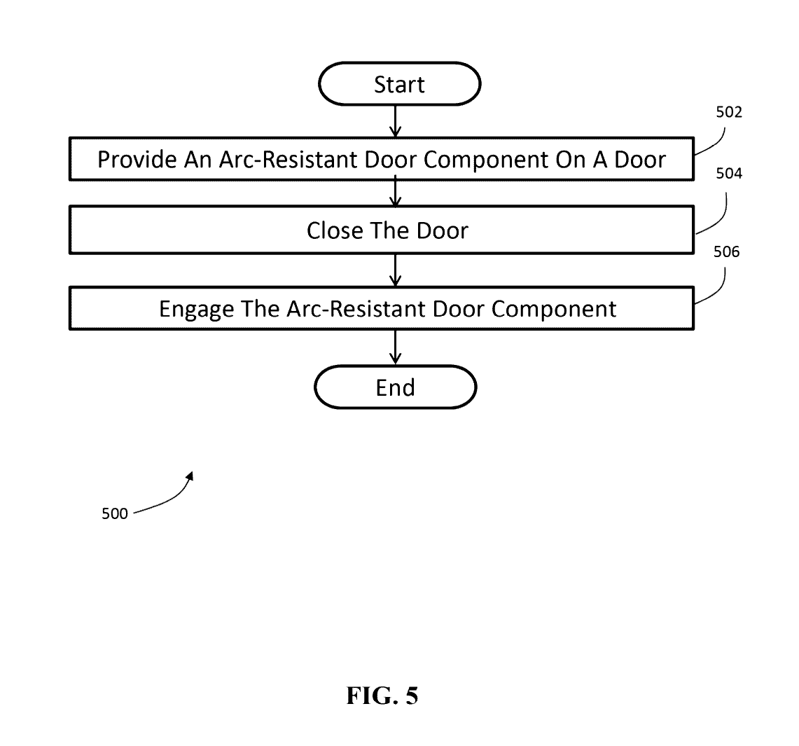

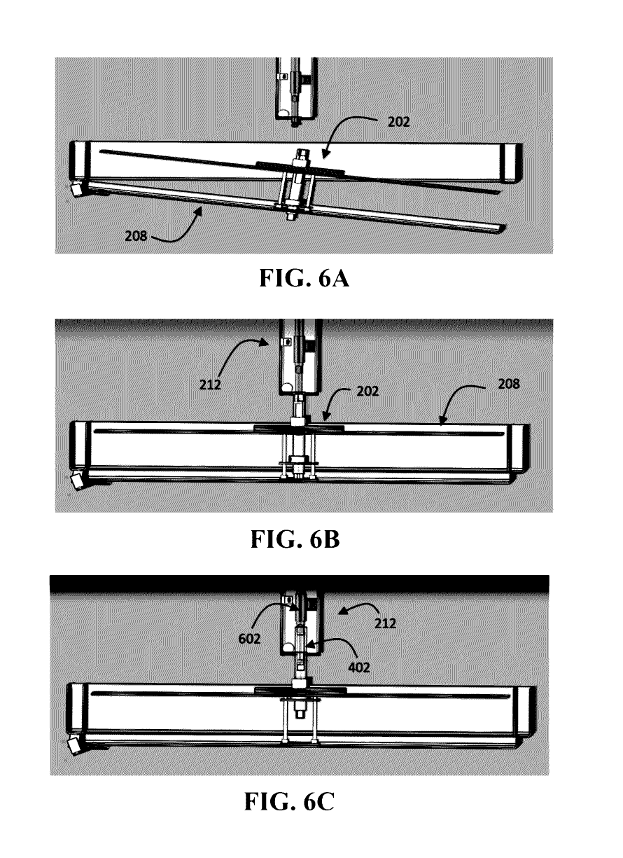

FIG. 5 illustrates an example method for creating an arc-resistant seal between a switchgear door and an internal racking mechanism and for providing arc-resistant access to the internal racking mechanism. At step 502, an example arc-resistant door component 202 is disposed inside an arc-resistant door 208 of an electrical switchgear, as illustrated in FIG. 6A. At step 504, the door 208 is moved to a closed position, thereby creating an arc-resistant seal between the inside chamber of the switchgear and the outside, as illustrated in FIG. 6B. The door 208 is positioned such that the arc-resistant door component 202 is aligned with the internal racking mechanism 212 of the switchgear. At step 506, the arc-resistant door component 202 engages the internal racking mechanism 212, as illustrated in FIG. 6C, responsive to a user engaging the arc-resistant door component 202. In particular, a user or an operator slides a hand tool onto the front of the shaft 402 and pushes inward until the rear of the shaft 402 engages onto a racking screw 602 of the internal racking mechanism 212. As the shaft 402 telescopes through the arc-resistant door component 202 and engages the internal racking mechanism 212, the collar 408 of the shaft 402 maintains contact with the slide 406 and creates an arc-proof seal.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof; and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed:

1. An arc-resistant electrical switchgear racking system, comprising:
an arc-resistant electrical switchgear comprising a chamber and an arc-resistant door configured to enclose the chamber;
an internal racking mechanism disposed inside the chamber, the internal racking mechanism configured to facilitate connection and disconnection of electrical components inside the chamber; and
a door component disposed in the arc-resistant door, wherein the door component is configured to engage the racking mechanism to provide an arc-resistant interface for accessing the internal racking mechanism, the door component comprising:
a shaft comprising a collar and configured to align and interface with the internal racking mechanism;
a slide for receiving the shaft via a guide hole; and
a compression spring to facilitate engagement of the collar with the slide.

2. The arc-resistant electrical switchgear racking system of claim 1, wherein the door component is disposed between a front door skin of the door and a rear door skin of the door.

3. The arc-resistant electrical switchgear racking system of claim 1, wherein the shaft is configured to engage the racking mechanism in order to cause internal components of the chamber to be connected or disconnected from live circuitry, based on a force applied to the shaft external to the chamber.

4. The arc-resistant electrical switchgear racking system of claim 2, wherein the door component further comprises:
a front mounting plate for mounting the door component to the front door skin of the door;
wherein the collar is disposed between the front mounting plate and the slide, and wherein the collar engages the slide to form a barrier preventing an arc blast occurring inside the chamber from passing through the door component.

5. The arc-resistant electrical switchgear racking system of claim 4, wherein the door component further comprises a rear guide plate for mounting the door component to the inner skin of the door, wherein the rear guide plate is configured to mate with an internal component racking screw housing.

6. The arc-resistant electrical switchgear racking system of claim 5, wherein the door component further comprises an inner slide support disposed on the rear guide plate and configured to facilitate shaft alignment and prevent shaft twisting as the shaft rotates.

7. The arc-resistant electrical switchgear racking system of claim 6, wherein the compression spring is disposed on a guide rail between the slide and the inner slide support for providing constant pressure to seal the slide against the collar.

8. The arc-resistant electrical switchgear racking system of claim 1, further comprising a protective housing to enclose the door component.

9. A door component for providing an arc-resistant interface for accessing the internal racking mechanism of an arc-resistant electrical switchgear, the door component comprising:
a shaft with a collar disposed on an end of the shaft, the shaft configured to rotate and move laterally and engage the internal racking mechanism responsive to being engaged by a hand tool external to the arc-resistant electrical switchgear;
a slide comprising a guide hole for receiving the shaft, and a flat portion for engaging the collar of the shaft on a first side of the slide to form a seal, the slide configured to move laterally in combination with the shaft responsive to the collar applying a force to the first side of the slide; and
a compression spring configured to provide pressure on the against the second side of the slide to facilitate engagement of the collar with the first side of the slide.

10. The door component of claim 9, further comprising a front mounting plate for mounting the door component to a front door skin of a switchgear door, the front mounting plate comprising a front guide hole for receiving the shaft, and a rear mounting plate for mounting the door component to a rear door skin of a switchgear door, the rear mounting plate comprising a rear guide hole for receiving the shaft.

11. The door component of claim 10, wherein the slide is disposed between the front mounting plate and the rear mounting plate, and wherein the door component further comprises a guide rod to facilitate linear lateral movement of the shaft between the front mounting plate and the rear mounting plate.

12. The door component of claim 10, wherein the door component further comprises an inner slide support disposed on the rear mounting plate and configured to facilitate shaft alignment and prevent shaft twisting as the shaft rotates.

13. The door component of claim 9, further comprising a protective housing enclosing the door component.

14. The door component of claim 9, wherein the guide holes of the front mounting plate, the slide, and the rear mounting plate are larger in diameter than the diameter of the shaft.

15. The door component of claim 14, wherein the larger guide holes are configured to allow the shaft some float to self-align itself with the internal racking mechanism.

16. The door component of claim 14, wherein the larger guide holes are configured to allow the shaft to rotate.

17. A method for providing arc-resistant access to an internal racking mechanism of an arc-resistant electrical switchgear, comprising the steps of;
disposing an arc-resistant door component comprising a shaft inside an arc-resistant door of an electrical switchgear;
closing the arc-resistant door to create an arc-resistant seal; and
engaging the shaft of the arc-resistant door component, externally to the door, with a hand tool, thereby causing the shaft to telescope through the arc-resistant door component and engage with a racking screw of the internal racking mechanism.

18. The method of claim 17, wherein the step of closing the arc-resistant door comprises aligning the arc-resistant door component with the internal racking mechanism.
